(19) United States
(12) Patent Application Publication
(10) Pub. No.: US 2012/0173325 A1
(43) Pub. Date: Jul. 5, 2012

(54) Using mobile devices to make secure and reliable payments for Title of Invention store or online purchases

(76) Inventor: Rajul Johri, West Jordan, UT (US)

(21) Appl. No.: 12/960,497

(22) Filed: Jan. 4, 2011

(51) Int. Cl. G06Q 30/00; G06Q 20/00; G06Q 40/00

(52) U.S. Cl. 705/14.38; 705/44; 705/17; 705/18

(57) ABSTRACT

Payment systems currently in vogue (credit/debit cards) use a form of identity applicable only to a specific payment network (card number). This prevents the aggregation of one's payment options, and exposes the sensitive account information to the relatively insecure parts (merchant locations) of the transaction chain.

This invention introduces an alternative platform for payments by aggregating the different identities under one. It proposes to use one's cellphone number as that identity. A set of configurable rules defined by the user let him/her choose the appropriate method of payment at the point of sale. The invention is a set of software and hardware components that work together to create a secure, robust and easy-to-use payment system. It also allows for fraud detection at the time it is being committed.

The advantage of this system is that it lets the users pay for their purchases only using their mobile phone.

### TECHNICAL FIELD AND INDUSTRIAL APPLICABILITY OF THE INVENTION

This invention relates to the use of mobile devices for making payments for store and web purchases

### BACKGROUND OF THE INVENTION

Credit cards have been around for nearly five decades (starting in 1950 with Diners Club) in the same form and seem to have missed the latest developments in technology. They have largely remained resistant to change in form (plastic card, rectangular shape etc.) and function (making payments).

There has been a flurry of activity recently in the payments industry to allow users to use different types of devices to make the payments. Most prominent amongst them are RFID enabled tags (which can be attached to mobile phones). All of these devices create a new ID (associated to the RFID device) in place of the credit card number and at the payment network, associate it with the credit account of the user. When the user brings these devices in close proximity to the reader at the checkout, this ID is transmitted wirelessly and the transaction is authorized against the credit account of the user.

The focus of all these new forms is the payment network. All these new forms are targetted to drive users to one or the other network. There is little effort to aggregate these different networks and let the user chose whichever network they wish to use for their payments. There is another kind of aggregation that is needed at the checkout. That is for the coupons/discounts that a person can use for the items purchased.

The current invention attempts to create a system which will do the aggregation discussed in [0005]. It will segregate the network identity of the user (their credit account) from their own identity. It will redefine the role of one's cellphone/mobile number as the core of ones identity. Use of the cellphone number instead of a complicated random large number is much easier for the user and allows for creating a payment-network-neutral ID. This ID can be associated to the different payment networks, the user is associated with. This same ID can be associated with all the discounts a person is eligible for and can be applied electronically.

There are obvious security issues with using a common ID such as ones cell phone number for purchases. The invention addresses all these security concerns in its design and in effect creates a system that is much more secure than any other alternative. It uses the two-factor authentication and allows for even three-factor authentication(what a person is, what a person has, what a person knows).

### INTRODUCTION

Credit cards need a makeover. They have been around for nearly five decades (started in 1950 with Diners Club) in the same form and seem to have missed the latest developments in technology. They have largely remained resistant to change in form (plastic card, rectangular shape etc.) and function (making payments). This resistance was justified even few years ago before mobile phones became prevalent. Then, a plastic card was the smallest form factor a person could carry with them that could convey their identity to a merchant. It was also not possible to verify that identity with a trusted third party without the phone line based POS* systems. This is not the case today. Not only do people carry a device (mobile phones) with them that uniquely identifies them (mobile numbers are unique, just as a credit card number) but this device is capable of communicating voice and data. So, ideally one should not need a credit card to convey their identity. It should be possible for merchants to charge one's credit/charge card account by knowing just their phone number. * POS—Point Of Sale system (the box which we use to swipe cards when making purchases)

There is no current system that allows users to complete their purchases using their cellphone numbers. This document describes a new system (LivewirePay) that will allow users to pay for their purchases only using their mobile phones or other such devices that uniquely identify them and can communicate over the wireless networks. Not only will this system allow users to carry a lighter wallet (or no wallet) but also will let them make purchases using a number they can easily remember (their mobile phone number). Other than the usual identity management, this system will allow users to navigate between their multiple credit cards and other accounts.

### Other Approaches And Their Limits

Some solutions in the mobile payment space are being attempted through RFID chips inserted in mobile phones. Those solutions are mainly aimed at automating/speeding-up the checkout process. They use the RFID tags to establish the identity. They also need significant technology upgrade on part of merchants and mobile manufacturers before mass adoption.

There are also some experiments being done to let users pay for their small online purchases using their mobile phones. In those cases, the phone company bills the purchase to the buyer on a monthly basis. These are a step in the right direction but they do not address the credit risk associated with a typical store transaction. In this model, Phone Company is the last entity left with credit risk. While it works for small transactions, it cannot work for regular day-to-day credit transactions because phone companies do not have the infrastructure to evaluate or carry the amount of credit risk inherent in regular credit transactions.

These approaches are payment network focused and are only trying to address the mechanics of data exchange for a given network. They are not inter-operable. For example, RFID tags provided by one network (say VISA) will not be applicable to another (say American Express). A system is needed that will convert one network identity into another. The proposed system (LivewirePay) is one such system. It is customer focused and segregates the personal identity of the user (their phone number) and the payment network identity. It aggregates various payment network identities under the personal identity of the user. It identifies the importance of credit risk underlying this data exchange. The system is built over the existing credit under-writing infrastructure. Issue of credit risk can be by-passed by attaching a checking account to the phone number.

### The LivewirePay System

The LivewirePay system is software that resides on the Internet and interacts with the following entities
Merchant's POS system
User's (purchaser) mobile phone
Credit issuer's authorization system or ACH system for debit payments
User personally over the web

Inside LivewirePay's secure database, the user's phone number is associated with one or more validated credit card accounts. It is possible to add one's checking accounts also. The rules to choose the right account to charge are also described within the system. These rules are chosen by the user from a menu of pre-defined ones while setting up their profile with LivewirePay system. Some of the possible rules are
Use the account with minimum balance (credit cards).
Use the account with maximum balance (checking accounts)
Use the account which cycles (billing date) after most number of days from today
Use the accounts in my list in order
Use different accounts based on the Reward programs offered by them.
Use account A for groceries, B for travel and C for all others.
Charge different accounts according to a fixed percentages of the total charge
Etc.

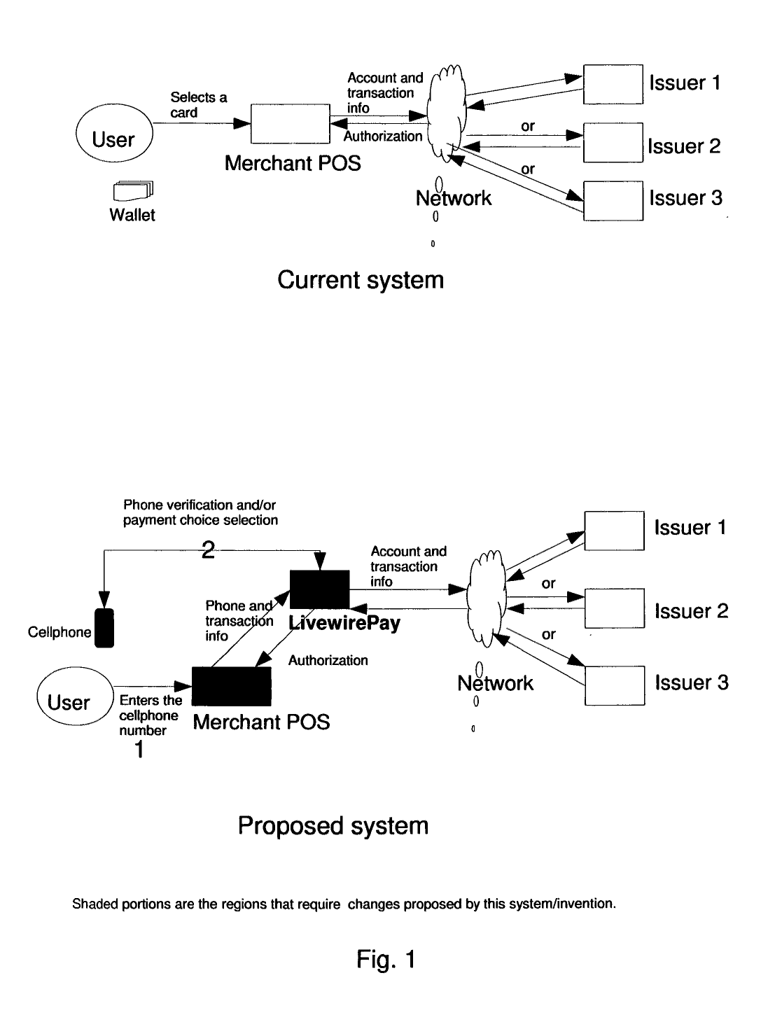

Here is the transaction flow that enables LivewirePay to complete payment transactions (also see FIG. 1)

Merchant LivewirePay→User's mobile→LivewirePay→Issuer's authorization system→LivewirePay→Merchant

LivewirePay receives a phone number and the usual transaction information (merchandise, category, quantity, price, merchant information etc.) as the input. The user may input their authentication code/PIN also at the POS terminal. The input comes from the merchant's POS system at the checkout**. Upon receiving the input, LivewirePay validates the user's identity (validating through the user's (purchaser's) phone number is one such method). This can be done either through SMS, text message, email or an automated voice response call depending upon the type of mobile device the user is carrying. ** User need not provide the merchant with the phone number directly. They may enter it much like they enter the debit card PIN. Privacy concerns around phone number can be addressed. There is another mode (automatic cell-phone detection) which is described later.

The user defines the verification information before-hand. The verification process is multi-moded, in the sense that there is not one key or password alone. While there are a passkey and PIN number, there also are unique shapes, little puzzles and also finger and Iris scans that only the user is supposed to be able to produce. The LivewirePay system utilizes this information to challenge the user while validating their identity. It uses a combination of transaction history and the current context to chose one or more methods to validate the user. The system aims to strike a balance between the quickest and safest means of verification appropriate for the circumstance. User verifies the transaction during the call. User may be able to chose a different account to charge along with the transaction verification. Additionally the LivewirePay system can store various coupons electronically and get those applied to the purchase automatically.

After verification, LivewirePay selects the account that satisfies the rules suggested by user (overrides it with the user's choice if received during verification) and proceeds to authorize the transaction with the selected account's payment system(s). Once the transaction is authorized, it returns an approval code to the merchant who then prints the checkout receipt.

LivewirePay system can be created as a new system or as an improvement to an existing payment system. The following changes will need to be made to the existing infrastructure of payment processing
Merchant's POS system will be altered to accept phone numbers and pass the transaction info along with the phone number to LivewirePay system.
LivewirePay system will be created that interfaces with merchants that originate the transactions and with major payment networks to authorize the transactions.
Users will register their phone number and credit cards with the LivewirePay system over the web.

### Other Features/Benefits

LivewirePay will let users keep their credit cards safely at home. This will help avoid the scenarios where hackers are able to get hold of credit card numbers of customers at a supermarket by hacking into the POS terminal. In this system, the sensitive information (credit card numbers) never comes out on insecure networks.
LivewirePay will allow users to alert all the payment networks at the same time in case of a breach.
LivewirePay will allow users to track their expenses on all their accounts in one central location.
LivewirePay could also grow large enough so that credit cards become virtual, thereby reducing the use of plastic.

### Conclusion

LiveWirePay is an easy, robust and secure method to allow users to make purchases and pay for them using just their mobile phone number. In addition to the ease of use, this solution allows users to make their purchases across different payment methods (credit cards, checking accounts etc) according to pre-selected rules. The system employs varying degree of security while verifying the transaction.

The main idea here is to securely validate the user first and only then access their payment identity. The current credit and debit products merge the two problems. They access the user's payment account directly through the swipe of a card. They assume that the person swiping the card is the user. The two processes (validate the user and apply the payment) need to be segregated. The advent of mobile phones and the easy availability of computing power and network access make such a segregation of concerns not only desirable but possible.

The possibility of employing multi-factor authentication (using something user has, something user knows and something user is) for LivewirePay system makes this a unique system for other applications where such authentication may be necessary.

### APPENDIX I—Legends

### Automatic Cellphone Registering System

The LivewirePay system will also include an automatic mode of cellphone detection. In this mode, the automatic identification of phone numbers (or other unique Ids) will ensure that the exact device/phone is used to make the payment. This mode will be activated if the users cell phone has the LivewirePay RFID tag and application installed on it and the merchant has a POS terminal equipped with the RFID reader running LivewirePay protocol.

In this mode, the POS will know the phone number of the buyer and will initiate the call to LivewirePay automatically without any input from the buyer. We describe below a system and a protocol to identify the LivewirePay system registered cellphone number of the person currently near a given POS. The system uses RFID technology to communicate with the RFID tag within the buyer's cellphone to “read” the cellphone number. The RF tag reader will be embedded in the POS system. A protocol is designed to locate the cellphone numbers from amongst a multitude of cellphones that could be present around the POS.

The protocol works not only with the phone number but ANY unique ID that may be associated with the mobile device as long as the ID is registered with LivewirePay. The protocol enables a much more secure transaction environment.

### RF Proximity Reader

This reader is part of the LivewirePay module installed in the POS system. This module works by communicating with the RFID tag associated with (located inside) the cellphone. An application on the RFID tag transmits the phone number to the RFID tag reader. The cellphone number is part of application data that gets exchanged between the RFID tag and the reader. This communication is fast and secure. It is designed to read the cell phone numbers within a predetermined radius of the POS system. It is possible for a POS to identify multiple cellphone numbers present nearby. There is an additional protocol followed to sort the cell phones according to their distance from the POS.

Once the reader is able to successfully “Identify” a number in its range, it acquires a “lock” on that number. To acquire a “lock”, the reader will attempt to read a tag twice. If both attempts are successful, a logical “lock” will be deemed present. The POS will query the user's photograph/name from the LivewirePay system at this level. After that, it will “monitor” the number. To “monitor” it will keep pinging the cellphone frequently to determine whether the phone is still within the range. A phone found to be within range for 10* consecutive reads will be the “designated” phone number. The POS will display the nearest “designated” phone numbers (it will just sort them in the ascending order of time taken to finish 10* reads). * POS—Point Of Sale system (the box which we use to swipe cards when making purchases)

After the checkout clerk has checked all the items and presses the check-out key, POS screen will display last few digits of the phone numbers along with the photographs/names. The buyer or checkout clerk will simply touch the appropriate name or photograph**. In case a photograph was used to initiate the transaction, there will be no need for user to validate the transaction through their phone as described in the original design. The same is true in the case of a displayed name, which can be validated against the user's driving license. If a photograph/name was not returned by the LivewirePay system, the buyer can just click on the appropriate phone number and complete the transaction by validating through their phone/POS. ** User need not provide the merchant with the phone number directly. They may enter it much like they enter the debit card PIN. Privacy concerns around phone number can be addressed. There is another mode (automatic cell-phone detection) which is described later.

Here are the various states a phone number goes through in this protocol. Each subsequent state (except the Excluded) subsumes the previous one and follows in sequence.

a) Identified This is a cell phone number the RFID tag reader is able to read successfully.

b) Locked This is a cell phone number which the RFID tag reader was able to successfully Identify in two successive trials. A given POS may have more than one locked cell phones. The name/photo is queried from the LivewirePay system.

c) Designated This is a cell phone number singled out after successful locking in 10* trials. The time taken to complete the 10* trials is recorded and used to rank the users near the POS. * POS—Point Of Sale system (the box which we use to swipe cards when making purchases)

d) Excluded These cellphone numbers belong to the personnel of the store and never enter the above states.
* The interval of 10 seconds for “designating” can be changed based on the store.
** This will allow the checkout clerk to identify the individual and make the transaction that much secure. This feature will make the use of phone numbers completely safe in stores. Even if an imposter manages to steal a phone, they can not get their picture/name to display on the checkout screen. This feature makes paying by phone completely safe from identity theft.

### Conclusion

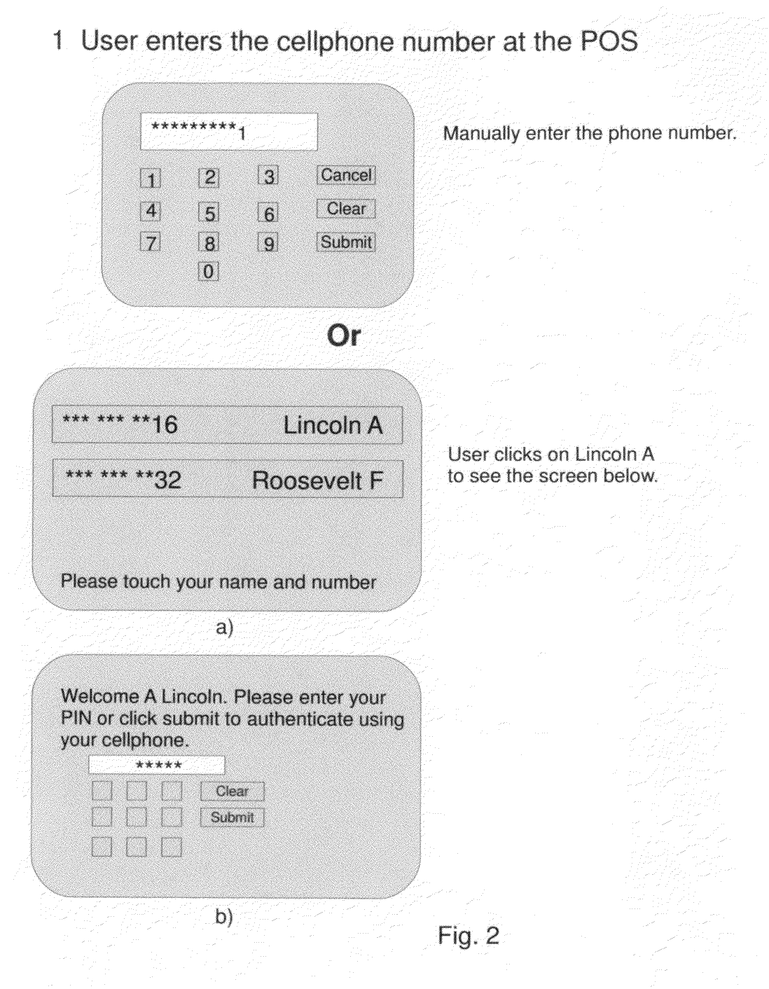

The system described here for accessing the users partial identity (cellphone number) is different from other RFID/NFC based approaches. Other approaches work by bringing the RFID tag very close (about 4 inches) to the reader. Here, we are interested in only the relative distance of different users. We are not interested in finding the one user closest to the POS. We are satisfied if we know that user A is closer to the terminal than user B. We use other means to chose the correct user (see FIG. 2) and then validate their identity.

Here again, we do not attempt to merge the personal identity with network identity. In other approaches, it is of paramount importance to be absolutely sure of the person closest to the terminal, because that identity is the network identity (account) of the user. Hence, in those situations, the distance is kept very small to reduce the chances of error. In LivewirePay, since the personal identity is separate from network identity, we can afford to be lenient in the solution of this problem. Also, since in LivewirePay, readers can read RFID tags over a larger distance, the scope of possible applications increases. e.g. this makes LivewirePay better suited for toll-booth applications since the user need not bring their card/phone in close proximity of the reader.

### BRIEF DESCRIPTION OF DRAWINGS

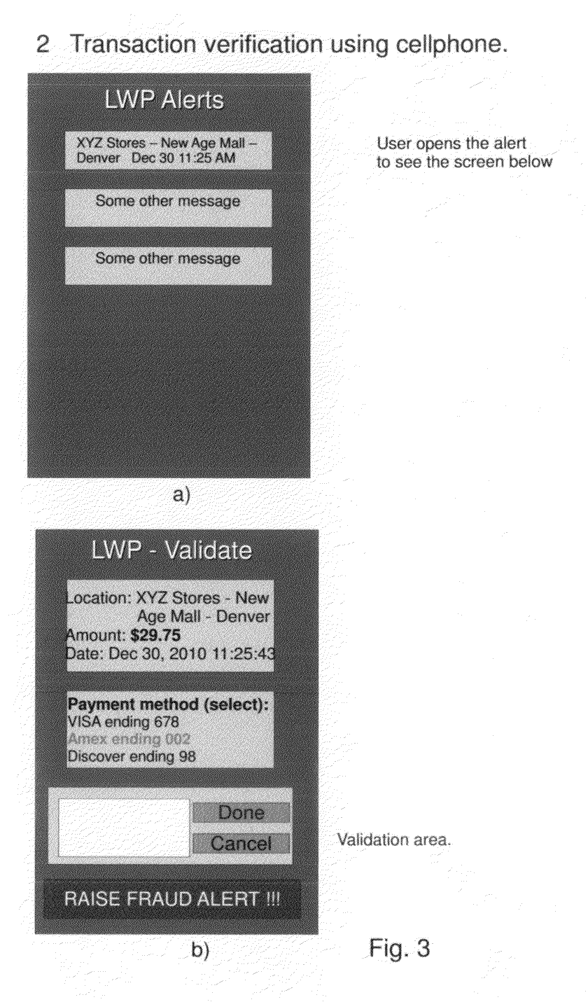

FIG. 1—Comparison of current and proposed payment systems.
In the current system user's account information (credit card number etc.) travels from user to the issuer and back. Authorization information travels from issuer to user.
Identifies the areas (shaded) of current payment system that will be impacted by LivewirePay system
   POS at the merchant
   Cell-phone of the user
   A new web-based LivewirePay payment system
In LivewirePay system, user's account information remains on the more secure private network, The choice of the payment method shifts to the network (in some cases it can revert back to the user through their cell phone Application)
Sections marked 1 and 2 in the proposed system area are described in more detail in FIG. 2 and FIG. 3

FIG. 2—Manual and automated methods of supplying ID to LivewirePay system
Top area of the figure depicts the manual ID entry screen at the POS
   In this mode, user does not get the option to enter the PIN. This mode is for online transactions or for the stores that do not have the Automatic cellphone registering System installed. It may be possible to have stores keep the option of manual entry of PIN, but online transactions have to have the cell-phone verification.
Bottom area (below the literal ‘Or’) features screens that system displays at the POS in the automatic ID detection mode.
   Screen a) displays the cell-phones located by the system (through RFID reader embedded within POS). They system displays the users in the order of their distance from the POS. It is possible to correct an error made by the system in detecting the relative distance. In the figure, the system found Lincoln A to be closer to the POS than Roosevelt F. If it is indeed Roosevelt F that is doing the transaction then user can select second name instead of the top one identified by the system.
   Screen b) lets the user enter their PIN on this screen.

FIG. 3—Transaction verification using cell phone
Screen a) shows the Inbox of the LivewirePay application on user's cell-phone
   User gets an alert message on their cellphone running the LivewirePay application. The Alert contains some identifying information about their current transaction.
Screen b) shows the transaction detail screen which user sees once they select their current transaction.
   The information on this screen comes from the information (such as the payment methods in their order of preference or according to the rules engine's output) the user provided while setting their account on LivewirePay website.
   In the example shown in the figure the LivewirePay system selected the payment method automatically and highlighted it (below “Payment Method (select)” literal). The user may chose a different method. In some cases the system can insert some fake method(s) in order to more vigorously authenticate the user.
   The area next to literal “Validation area” is where the user provides the authentication information (a PIN number, a passkey or chooses one amongst a few pictures) and presses Done to indicate their validation.
   The last button on the screen is the “Raise Fraud Alert” button. The user clicks this button if they do not recognize this transaction. It sends an alert in the middle of the transaction. This feature amongst others makes LivewirePay a really secure system. Upon receiving this alert. LivewirePay system takes mitigation steps to secure the user's identity, alert merchant and possibly law enforcement also. Notice that this all happens when the transaction is still active.

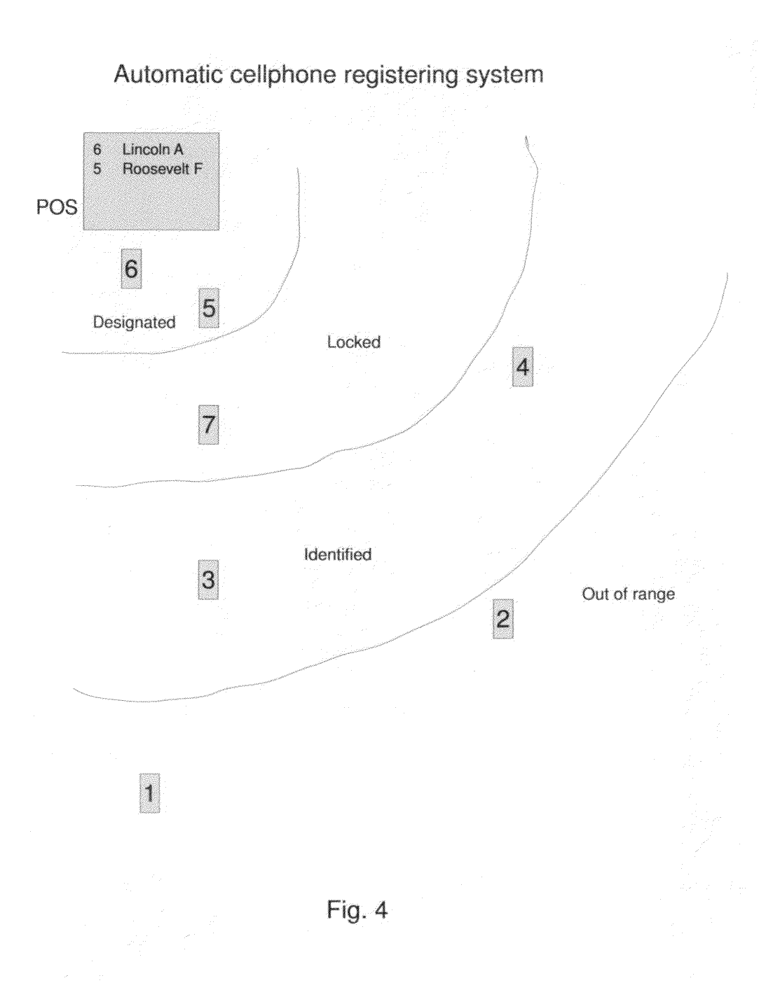

FIG. 4—A schematic of automatic cell-phone registering system.
The registering system is embedded within the POS and communicates with the RFID tag in the cellphones (depicted as 1-7). Once a phone is Identified, it queries the name of the person from LivewirePay online system. This usage of RFD tag is very different from alternative approaches of implementing contactless payments. There, RFID tag stores either the account information or some variant of it. There, the tag needs to be brought very close to the POS. Not so in this case. Here, the tag is just a means to transfer a public key (phone number). It is paired with a private key at the time of transaction.
Another distinguishing aspect of this registering system is its tolerance for ambiguity. It tries to make the best effort to resolve the relative distances of Designated phones. User at the checkout manually selects the appropriate phone number. If there is only one user Designated, the system only shows a “Check-out” button, which the user clicks and proceeds with check-out.
Here is a status of all the cellphones within the registering system based on the layout in FIG. 4. Last column contains the times in milliseconds it took for the system to finish 10 complete “lookups” of designated cellphones. This is the number used to rank the cellphones (less ranks higher). Multiple lookups are done to even out the random fluctuations in one lookup.

| | | | | |
|---|---|---|---|---|
| 1 | | | | |
| 2 | | | | |
| 3 | Identified | | | |
| 4 | Identified | | | |
| 5 | Identified | Locked | Designated | 765 |
| 6 | Identified | Locked | Designated | 583 |
| 7 | Identified | Locked | | |

What is claimed is:

1-9. (canceled)

10. A method and system to segregate personal and network/financial identities of a person and validating them separately comprising these steps
a) Creating four separate data stores (A, B, C and D)
b) Storing financial identity information (credit cards, account numbers) in D and allowing access to this store only from datastore B upon validation of a personal user PIN.
c) Storing personal information (name, addresses, age, photographs and other personal information) keyed to their mobile device number in C and allowing access to this store only from datastore B upon a valid merchant request.
d) Storing authentication information (mobile device numbers, personal PIN, passwords, picture choices, biometric data and other information required to validate a personal identity) in B and allowing access to this store only from datastore A upon a valid merchant request.
e) Storing merchant information (their merchant ID, access levels, keys etc) in datastore A and opening restricted access to it over the network.
f) Logging all accesses to all datastores (querying IP address, merchant ID, query time and other transaction information).

11. A machine to detect a mobile device and detect/display associated personal identity information within a configurable range (up to 100 feet) comprising these steps
a) Equipping the mobile device with an RFID tag (either attach it in the sticker form to the outside of mobile device or embed it with its circuit/motherboard).
b) Equipping the said machine with an RFID reader of required read range (the distance it can detect an RFID tag from).
c) Embedding the mobile device number of the user in an encrypted form on the RFID tag.
d) Bringing the mobile device within the said machine's range so that it reads the encrypted phone number by detecting the RFID signal emanating from the mobile device's RFID tag. Alternatively, entering a plain (unencrypted) cellphone number in the said machine.
e) Connecting the said machine to some network (internet or a private network) capable of accessing datastore A in claim 10
f) Sending the mobile device number read in step d along with merchant identification to the datastore A and receiving the personal identity information in datastore B through datastore A of claim 10.
g) Said machine either displaying or storing for further use, the information received in step f.

12. A method to display or detect personal identification information of multiple persons who are within the read range of said machine and ordering this information according to their distance from the said machine comprising these steps
a) Measure the time taken to do multiple reads of an RFID tag from the said machine.
b) Repeat step a for each RFID tag in the range and store the time taken for every mobile device number read.
c) Retrieve the personal identification information for each mobile device number read as in claim 11.
d) Either display or store the information sorted by increasing order of time recorded in step b.

13. A method and system for authorizing a financial transaction using the said machine comprising these steps
a) Setting up appropriate access to allow financial transaction in datastore A of claim 10 for the merchant hosting the said machine.
b) Collecting the financial transaction information (item(s) sold, amount, date, time, merchant ID) in the said machine (passing this information from a POS to the said machine).
c) The said machine prompting the person doing the financial transaction to enter their authentication info (PIN, answer of a personal question or biometric information) and select the preferred financial instrument.
d) Sending the information from step c to datastore B through A of claim 10.
e) Matching the authentication information collected in step c with that stored in datastore B of claim 10
f) Upon successful completion of step e, sending this transaction information to datastore D of claim 10 and selecting the suitable financial instrument for the transaction based on person's predetermined selections if not provided as part of transaction request.
g) Authorizing the transaction with the selected financial instrument and institution and sending the result back through datastore A to the said machine.

14. A method and system for capturing the image of the person conducting the transaction of claim 13 through the said machine and attaching it to the financial transaction information comprising these steps
a) Equipping the said machine with a camera capable of taking the picture of the person transacting through it.
b) Returning an instruction code from datastore A of claim 10 as part of the response for the personal identity information of claim 11, which instructs the camera to return the picture of the person for a financial transaction using the said machine.
c) Capturing the picture of the person in front of the said machine and including it as part of the financial transaction information as in claim 13 step c.
d) Returning (optionally) of a similar instruction code as in step b with the response for the financial transaction. This code instructs the said machine to send the picture after the financial transaction is conducted as against before as in step c.

15. A method and system for authorizing a financial transaction of claim 13 using the person's mobile device comprising these steps
a) Setting up the personal preference to do mobile device based authentication for financial transaction as part of personal profile in datastore B of claim 10.
b) Collecting the financial transaction information (item(s) sold, amount, date, time, merchant ID) in the said machine and sending it to data store A of claim 10.
c) The said machine not prompting the person for any input and displaying some filler message (“Waiting for authorization” message, advertisement etc).
d) Sending the transaction notification with the information in step b to person's mobile device and prompting them to enter their authentication info (PIN, answer of a personal question or biometric info) and select the preferred financial instrument through the mobile device.
e) Sending the information from step d to datastore B through A of claim 10.
f) Matching the authentication information collected in step d with that stored in datastore B of claim 10
g) Upon successful completion of step f, sending this transaction information to datastore D of claim 10 and selecting the suitable financial instrument for the transaction based on person's predetermined selections if not provided as part of step d.
h) Authorizing the transaction with the selected financial instrument and institution and sending the result back through datastore A to the said machine and mobile device.

16. A method to create and manage the information stored in the datastores A, B, C and D of claim 10 comprising these steps
a) User logging into a web based portal site using their mobile device number, create the information appropriate for them (merchants create their business information, users create their personal, authentication and financial instruments information).
b) Users defining the rules to select the appropriate financial instrument based on the circumstances.
c) Storing the information from step a in datastores as in claim 10.
d) Users logging into the said portal to view the latest transactions (personal identity requests and financial transactions) and picture of the person who conducted a financial transaction.
e) Users logging into the said portal to change their authentication settings (changing their PIN, passwords etc.)
